(19) United States
(12) Patent Application Publication
(10) Pub. No.: US 2025/0324975 A1
(43) Pub. Date: Oct. 23, 2025

(54) Magnetic Fungicide

(71) Applicants: Kateryna Skliarenko, Los Angeles, CA (US); Anna Shiriaeva, Los Angeles, CA (US); Bogdanov Viktor, Menden (DE)

(72) Inventors: Kateryna Skliarenko, Los Angeles, CA (US); Anna Shiriaeva, Los Angeles, CA (US); Bogdanov Viktor, Menden (DE)

(73) Assignees: Kateryna Skliarenko, Los Angeles, CA (US); Viktor Bogdanov, Menden (DE); Anna Shiriaeva, Los Angeles, CA (US)

(21) Appl. No.: 18/641,362

(22) Filed: Apr. 20, 2024

(51) Int. Cl. A01N 59/20; A01N 25/04; A01N 25/08; A01P 3/00

(52) U.S. Cl. CPC A01N 59/20; A01N 25/04; A01N 25/08; A01P 3/00

(57) ABSTRACT

The present invention is fungicide with magnetic properties for controlling fungal disease in plants that allows magnetic-field-guided delivery of fungicide onto the plant matter and provides the possibility to extract the fungicide particles from soil and plant matter and recycle. The fungicide comprises particles of magnetic material and fungicidal compound.

### FIELD OF THE INVENTION

This invention relates to fungicide, and more particularly to an inorganic fungicide for plants.

### PRIOR ART

### Patent Citations

1. Kuprovin-Agro (Patent UA30246 (U) dated 2008 Feb. 25)
2. U.S. Pat. No. 9,307,693B2 describes microcapsules adapted to rupture in a magnetic field that encapsulate an agricultural chemical, such as a fertilizer, herbicide or insecticide.
3. JP2017539080A describes a method of preparation of polymer-encapsulated magnetic nanoparticles.
4. CN110899317A Cadmium-polluted farmland soil remediation method based on magnetic biochar
5. KR20220138536A Self-propelled adsorbent and a method for purifying contaminated water

### Non-Patent Citations

1. Le Wee, J., Law, M. C., Chan, Y. S., Choy, S. Y., & Tiong, A. N. T. (2022). The potential of Fe-based magnetic nanomaterials for the agriculture sector. ChemistrySelect, 7(17), e202104603.
2. Spanos, A., Athanasiou, K., Ioannou, A., Fotopoulos, V., & Krasia-Christoforou, T. (2021). Functionalized magnetic nanomaterials in agricultural applications. Nanomaterials, 11(11), 3106.
3. Wang, T., Al, S., Zhou, Y., Luo, Z., Dai, C., Yang, Y., . . . & Luo, L. (2018). Adsorption of agricultural wastewater contaminated with antibiotics, pesticides and toxic metals by functionalized magnetic nanoparticles. Journal of environmental chemical engineering, 6(5), 6468-6478.
4. Lee, D., Choi, K. S., Kim, D., Park, S., Kim, W., Jang, K. J., . . . & Kim, J. (2017). Iron oxide nanoparticle-incorporated alginate capsules as magnetic field-assisted potential delivery platforms for agriculture pesticides and biocontrol agents. Journal of Biosystems Engineering, 42(4), 323-329.
5. Aylaz, G., Kuhn, J., Lau, E. C., Yeung, C. C., Roy, V. A., Duman, M., & Yiu, H. H. (2021). Recent developments on magnetic molecular imprinted polymers (MMIPs) for sensing, capturing, and monitoring pharmaceutical and agricultural pollutants. Journal of Chemical Technology & Biotechnology, 96(5), 1151-1160.
6. Hubetska, T. S., Kobylinska, N. G., & Menendez, J. G. (2020). Application of hydrophobic magnetic nanoparticles as cleanup adsorbents for pesticide residue analysis in fruit, vegetable, and various soil samples. Journal of Agricultural and Food Chemistry, 68(47), 13550-13561.

### BACKGROUND OF THE INVENTION

The control of fungal growth is essential as the unrestrained proliferation of fungi on plants or plant constituents disrupts the maturation of foliage, fruits, or seeds, thereby detrimentally impacting the overall quality of cultivated crops.

Global agricultural practitioners incur annual losses ranging from 10% to 23% due to fungal diseases affecting crops. Notably, grapes experience a substantial yield reduction of 12% as a consequence of a specific fungal ailment. Recognizing the substantial economic repercussions associated with fungal proliferation in agricultural and horticultural contexts, a diverse array of fungicidal and fungistatic products has been developed to address both general and targeted applications.

Addressing fungal plant diseases, the most effective approach is using fungicides containing copper as their active ingredient. However, the downside of employing these fungicides is the potential dispersal of copper into the environment, leading to pollution and ecological damage. Therefore, there is a pressing need for a method to curb the spread of copper.

Enhancing fungicides to boost their efficacy and mitigate environmental impact involves strategies such as enlarging the contact area, augmenting adhesion to the plant surface, and optimizing the controlled release of copper ions. These key parameters significantly influence both targeted and non-target fungicide consumption. Although these indicators play a pivotal role, they do not fully determine the feasibility of precisely targeted copper distribution and subsequent recycling.

The prevailing techniques for fungicide application delineate two avenues of copper distribution and concentration: on the plant surface (designated as target copper) and in the surrounding space (referred to as non-target copper). Target and non-target copper lack natural recycling mechanisms. Nevertheless, the copper adhering to the plant surface can be technically managed by subsequent disposal along with naturally decaying plant parts. Conversely, non-target copper, whether missing its intended destination or being dislodged from the plant surface by atmospheric forces, disperses into the environment uncontrollably. Therefore, to mitigate the adverse impacts of copper fungicides, it is crucial to minimize the amount of copper that affects non-target areas and to thoroughly remove it from the environment. This invention is intended to mitigate copper spread by combining copper fungicide with magnetic material and using a magnetic field to control the distribution in the environment.

Among all magnetic materials, iron-based magnetic materials hold particular significance in agricultural applications due to their abundance, cost-effectiveness, and lower environmental risk compared to the other ferromagnetic materials containing cobalt, nickel, and manganese.

The present invention enables controlled delivery of fungicide onto the plant matter and facilitates extraction and recycling of fungicide from soil that is misapplied or displaced from the plant surface due to atmospheric factors.

### OBJECTS OF THE INVENTION

The purpose of the present invention is to create a new fungicide that allows magnetic field-controlled delivery and extraction of the fungicide from the environment. This will reduce the environmental spread of copper without reducing the required concentration of fungicide per unit area of the treated surface of plant matter.

### SUMMARY OF THE INVENTION

The present invention is a fungicide in the form of slightly soluble microparticles (aggregates) up to 100 micrometers in size, containing copper compounds and magnetic material. The magnetic material used is iron oxide (Fe₃O₄-magnetite) or other safe substances with magnetic properties. The size of the magnetic inclusions is approximately 6% of the total particle volume or about 8% by weight. The Fe:Cu ratio is around 1:10. Magnetic characteristics allow these particles to be efficiently guided to the desired location and subsequently extracted from the environment after application and recycled. Distribution and extraction of particles can be controlled by magnetic fields.

### DETAILED DESCRIPTION

The claimed fungicide, in contrast to the other known fungicides, enables the regulation of fungicidal copper release into the environment. This enables the utilization of copper fungicides without inducing further environmental damage. The regulation is achieved through the predictability of magnetic particle behavior in a magnetic field. By imparting magnetic properties to fungicide particles, they are attracted to the magnetic field source through magnetic forces. Consequently, a transient magnetic field can be generated in the plant vicinity to concentrate fungicide particles during treatment and extract those from the soil that did not adhere or were removed from the plant matter by environmental conditions.

The particle size of commercially used copper fungicides ranges from 0.15 to 2 microns. These small particles are very mobile and active in the environment. Introducing the magnetic core to a fungicidal particle would increase particle size to 15-20 microns, which will not significantly alter the adhesion to the surface of the plant or fungicidal activity of copper compounds. These particles can be effectively distributed, collected and recycled using magnetic fields.

The preparation of the magnetic fungicide is conducted as follows. In the process of depositing copper from an acidic solution, insoluble particles of magnetite or other magnetic material are introduced into the solution alongside the precipitant. As the deposit forms, aggregates comprising deposited copper compounds and magnetic material are generated. Achieving a weight ratio of iron to copper (Fe:Cu) at 1:10 ensures the aggregated particle possesses sufficient magnetic properties for an effective response to an external magnetic field. The average size of these aggregated particles can range between 15-20 microns, with magnetic inclusions, such as magnetite, of approximately 6-7 microns or around 6% by volume and 8% by weight. The generation of magnetic fungicide particles can be accomplished through other established methods, including coagulation or encapsulation. Fungicide-containing magnetic particles maintain fungicidal activity and magnetic properties in the following range of concentrations: fungicide (20-90% w/w), magnetic material (10-40% w/w) and polymer (0-80% w/w).

Precise delivery of fungicide active ingredients to plants is controlled by a short-term magnetic field that is generated around the sprayed plant, effectively capturing the flow of fungicide particles within this magnetic field. Extracting and repurposing of residual unreacted ingredients is done by magnetic field with specific strength and direction.

What is claimed is:

1. Magnetic fungicide particles comprising magnetic material attached to fungicidal compound.

2. Magnetic particles according to claim 1, further comprising a matrix such as polymer or silicon hydrogel.

3. Magnetic particles according to claim 1, containing basic copper carbonate fungicide (20-90% w/w), magnetite Fe₃O₄ as magnetic material (10-40% w/w) and polymer (0-80% w/w).

4. A method for preparation of magnetic particles composed of fungicide and magnetic material (e.g., Fe₃O₄ or other magnetically responsive and safe substances) with potential addition of an adhesive matrix (silica gel, polymer). Particles are prepared from the acidic copper solution (for example, obtained by leaching) by introducing magnetic particles (and polymer if necessary) along with the precipitant (sodium carbonate) using methods of co-precipitation, coagulation or encapsulation. Resulting particles contain copper fungicide with magnetic inclusions.
